(19) United States
(12) Patent Application Publication
(10) Pub. No.: US 2023/0129329 A1
(43) Pub. Date: Apr. 27, 2023

(54) GUIDANCE MODES FOR AN UNMANNED AERIAL VEHICLE

(71) Applicant: AURORA FLIGHT SCIENCES COPORATION, A SUBSIDIARY OF THE BOING COMPANY, MANASSAS, VA (US)

(72) Inventor: Robert A. Vivona, Arlington, MA (US)

(21) Appl. No.: 17/452,148

(22) Filed: Oct. 25, 2021

(51) Int. Cl. G08G 5/00; G05D 1/10; G08G 5/06; B64C 39/02

(52) U.S. Cl. CPC G08G 5/003; B64C 39/024; G05D 1/106; G08G 5/065; B64C 2201/12

(57) ABSTRACT

A method is provided for supporting operations of an unmanned air vehicle (UAV) on a flight in an airspace system. The method includes receiving instructions that describe a cleared path the UAV is authorized by an air navigation service provider (ANSP) to travel through the airspace system. The method includes determining guidance modes of the UAV based on the instructions, and engaging the guidance modes in which the UAV is caused to perform the procedures to carry out the flight. The guidance modes indicate procedures of the UAV, the guidance modes including lateral flight modes and vertical flight modes, that are subject to rules defined by the ANSP for travel through the airspace system under instrument flight rules (IFR), and the lateral flight modes and the vertical flight modes are separate and independent from one another.

### TECHNOLOGICAL FIELD

The present disclosure relates generally to robotics and, in particular, to one or more of the design, construction, operation or use of autonomous robots such as autonomous or semi-autonomous vehicles.

### BACKGROUND

Many modern robots and other machines are designed to operate with increased autonomy. Some of these modern robots are manned while others are unmanned. In particular, a variety of unmanned vehicles include unmanned ground vehicles (UGVs), unmanned aerial vehicles (UAVs), unmanned surface vehicles (USVs), unmanned underwater vehicles (UUVs), unmanned spacecraft and the like. The use of unmanned vehicles has grown in recent years and these unmanned vehicles are employed in a wide variety of applications, including both military and civilian uses.

One focus in the field of robotics is in the improvement of autonomy, which often includes multiple aspects of robot operation. These aspects of robot operation include automatic control of a given robot to support remote human control. Another aspect is optimization systems (and associated methods) to determine how, for a given robot or set of robots, tasks should be ordered and/or allocated. And yet another aspect of robot operation is automatic, real-time or near real-time data processing, and exploitation in support of automatic route planning, mission execution and other activities.

Despite advancements, existing autonomy systems are typically configured to address only one aspect of these activities, thereby focusing its design of the underling autonomy algorithms and software architecture on a narrow mission set. This limits the extensibility of existing autonomy systems. Furthermore, it is generally desirable to improve existing systems to enhance their efficiency and operation.

It would therefore be desirable to have a system and method that takes into account at least some of the issues discussed above, as well as other possible issues.

### BRIEF SUMMARY

Various types of robots and in particular UAVs employ guidance modes for flights under an instrument flight rules (IFR) flight plan. Some of these guidance modes have been considered for UAVs in visual flight rules (VFR) and special use airspace (SUA) applications. Example implementations of the present disclosure therefore provide guidance modes and their high-level operation for a UAV. The guidance modes of example implementations may include ground modes, air-ground transition modes, and airborne flight modes.

The guidance modes of example implementations may include sub-modes for the ground modes, air-ground transition modes, and airborne flight modes, as well as respective operation commands. In this regard, transitions of different types may be defined between the modes and sub-modes, and these transitions may include certain conditions to fulfill before the UAV transitions from one mode to another mode. Based on these conditions and any additional input, such as from a control station, the UAV may decide to switch to the next guidance mode or follow a command from the additional input.

The present disclosure thus includes, without limitation, the following example implementations.

Some example implementations provide an apparatus for supporting operations of an unmanned air vehicle (UAV) on a flight in an airspace system, the apparatus comprising: a memory configured to store computer-readable program code; and processing circuitry configured to access the memory, and execute the computer-readable program code to cause the apparatus to at least: receive instructions that describe a cleared path the UAV is authorized by an air navigation service provider (ANSP) to travel through the airspace system; determine guidance modes of the UAV based on the instructions, the guidance modes indicating procedures of the UAV, the guidance modes including lateral flight modes and vertical flight modes, that are subject to rules defined by the ANSP for travel through the airspace system under instrument flight rules (IFR), and the lateral flight modes and the vertical flight modes being separate and independent from one another; and engage the guidance modes in which the UAV is caused to perform the procedures to carry out the flight.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S

Having thus described example implementations of the disclosure in general terms, reference will now be made to the accompanying figures, which are not necessarily drawn to scale, and wherein:

FIG. 1 illustrates one type of robot or more particularly aircraft, namely, an unmanned aerial vehicle (UAV), that may benefit from example implementations of the present disclosure;

FIG. 2 illustrates a system according to some example implementations;

FIG. 3 illustrates a scenario in which the UAV is executing a mission, according to some example implementations;

FIG. 4 illustrates various guidance modes of the UAV, according to some example implementations;

FIG. 5A illustrates a first scenario in which various ground, air-ground transition and airborne flight modes are engaged, according to some example implementations;

FIG. 5B illustrates a second scenario in which various ground and air-ground transition modes are engaged, according to some example implementations;

FIGS. 6A, 6B and 6C illustrate the UAV in a lateral navigation mode over three scenarios, according to some example implementations;

FIGS. 7A, 7B, 7C and 7D illustrate other lateral flight modes of the UAV, according to some example implementations;

FIGS. 8A, 8B, 8C and 8D illustrate vertical flight modes of the UAV, according to some example implementations;

FIGS. 9A and 9B illustrate scenarios including an approach mode to respectively a landing and a missed approach, according to some example implementations;

FIG. 10 illustrates a scenario in which the landing and taxi modes are engaged, according to some example implementations;

FIGS. 11 and 12 illustrate scenarios in which various airborne flight, air-ground transition, and ground modes are engaged, according to some example implementations;

FIG. 13 is a flowchart illustrating various steps in a method of supporting operations of a UAV on a flight in an airspace system, according to various example implementations; and

FIG. 14 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure relate generally to robotics and, in particular, to one or more of the design, construction, operation or use of robots. As used herein, a robot is a machine designed and configurable to execute maneuvers in its environment. The robot may be manned or unmanned. The robot may be fully human-controlled, or the robot may be semi-autonomous or autonomous in which at least some of the maneuvers are executed independent of or with minimal human intervention. In some examples, the robot is operable in various modes with various amounts of human control.

A robot designed and configurable to fly may at times be referred to as an aerial robot, an aerial vehicle, an aircraft or the like. A robot designed and configurable to operate with at least some level of autonomy may at times be referred to as an autonomous robot, or an autonomous aerial robot, autonomous aerial vehicle or autonomous aircraft in the case of an autonomous robot that is also designed and configurable to fly. Examples of suitable robots include aerobots, androids, automatons, autonomous vehicles, explosive ordnance disposal robots, hexapods, industrial robots, insect robots, microbots, nanobots, military robots, mobile robots, rovers, service robots, surgical robots, walking robots and the like. Other examples include a variety of unmanned vehicles, including unmanned ground vehicles (UGVs), unmanned aerial vehicles (UAVs), unmanned surface vehicles (USVs), unmanned underwater vehicles (UUVs), unmanned spacecraft and the like. These may include autonomous cars, planes, trains, industrial vehicles, fulfillment center robots, supply-chain robots, robotic vehicles, mine sweepers, and the like.

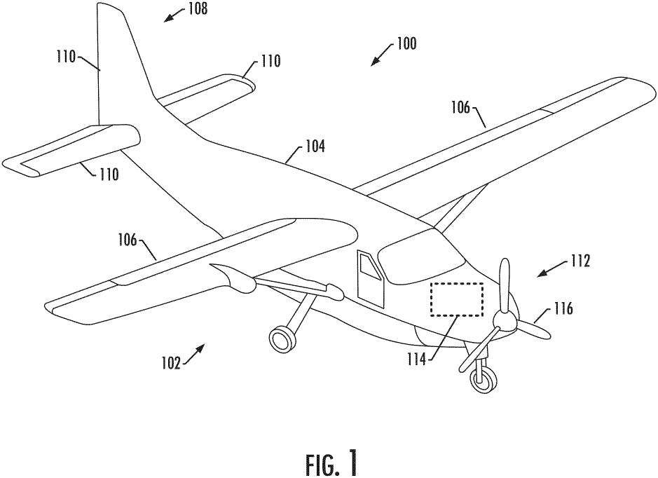

FIG. 1 illustrates one type of robot or more particularly aircraft, namely, a UAV 100, that may benefit from example implementations of the present disclosure. As shown, the UAV generally includes a basic structure 102 with an airframe including a fuselage 104, and one or more pairs of wings 106 that extend from opposing sides of the fuselage. The airframe also includes an empennage or tail assembly 108 at a rear end of the fuselage, and the tail assembly includes stabilizers 110. The UAV further includes a propulsion system 112 with an engine 114 configured to power a propulsor 116 to generate propulsive forces that cause the UAV to move. On the UAV as shown, the propulsor is a propeller. Depending on the UAV, in various examples, the propulsors include one or more of rotors, propellers, jet engines or wheels.

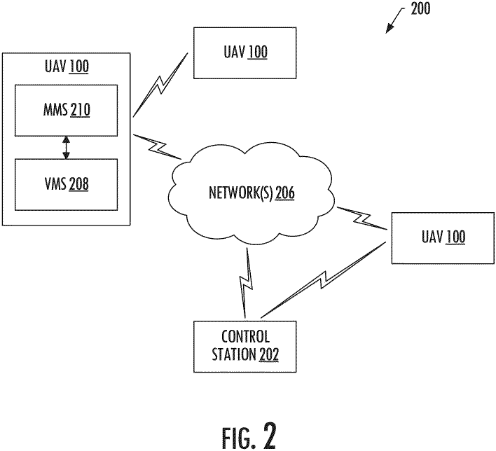

FIG. 2 illustrates a system 200 according to some example implementations of the present disclosure. The system may include any of a number of different subsystems (each an individual system) for performing one or more functions or operations. As shown, in some examples, the system includes a control station 202 and one or more robots such as one or more UAVs 100. The control station provides facilities for communication with or control of the one or more UAVs, such as by wireless data links directly or across one or more networks 206. In some examples, the control station may be a ground station, and not in all cases control the UAVs. In this regard, the control station may be configured to monitor the UAVs. The control station may initiate mission, but the control station may not control the UAVs to maneuver. At times, then, the control station may enable or provide a distributed network/server of software functions.

The UAV 100 includes a robot management system (RMS) implemented as a vehicle management system (VMS) 208. The RMS is a robot-specific subsystem configured to manage subsystems and other components of the robot, and the VMS is a particular RMS implementation for a vehicle such as a UAV. These subsystems and other components include, for example, maneuver controls, landing gear, onboard environmental systems, electrical, pneumatic and hydraulic systems, communications systems, navigation systems and other subsystems and components for controlling operation and maneuvering of the robot. The RMS / VMS is configured to accept maneuver commands such as waypoints and/or steering commands, and control the robot / UAVs to follow those maneuver commands.

The UAV 100 also includes a mission management system (MMS) 210. The MMS is a subsystem configured to manage missions of the UAV. A mission is a deployment of the UAV (one or more UAVs) to achieve one or more mission objectives. A mission may be decomposed into maneuvers of the UAV with optional sensor and/or effector scheduling, and the MMS may execute tasks to manage the UAV to execute maneuvers with specific parameters and capabilities. The MMS 210 includes subsystems to process sensor data to situational awareness, plan tasks for the UAV (or multiple UAVs), coordinate with teams to assign tasks, execute assigned tasks. The MMS is also configured to interface with the VMS 208, and in some examples the control station 202. Although the MMS is shown on the UAV, the MMS may instead be at the control station; or in some examples, the MMS may be distributed between the UAV and the control station.

In some examples, the MMS 210 provides a complete, end-to-end autonomy architecture with open system architecture standards and parameterized to allow rapid extension and reapplication to a variety of robots including the UAV 100. The flexibility of the MMS enables an operator to code it once, but to apply it anywhere. The MMS may therefore be applied to virtually any robot that applies, or benefits from, autonomy. The MMS may include an adaptable autonomy architecture that is applicable to a variety of robots, including those identified above. A benefit of the MMS is therefore not only in the specific contents, but also in the specific details of the architecture, its subroutines, and in the interfaces between those subroutines and other systems/devices that support rapid extensibility and adaptability of the MMS to a variety of domains.

According to some example implementations of the present disclosure, the MMS 210 is also configured to implement software functionality or functionalities (at times referred to as services) during a mission to support the UAV 100. FIG. 3 illustrates a first scenario 300 in which the UAV 100 is executing a mission in which the UAV maneuvers in an airspace system 302. The airspace system is served by an air navigation service provider (ANSP), and includes an airspace, infrastructure and rules, regulations and the like for navigating the airspace. The ANSP is generally a public or private entity that provides air navigation services, and manages air traffic for an organization, region or country. One example of an ANSP in the United States is the Federal Aviation Administration (FAA). Examples of suitable airspace systems include the National Airspace System (NAS) and the new NextGen system that are served by the FAA.

During the mission, the UAV 100 may be authorized by the ANSP to travel a cleared path 304 through the airspace system 302, and the cleared path may be described by a series of waypoints 306 that define a route the UAV will travel, as well as points 308, 310 at which an autonomous landing is initiated and the UAV lands at an airport 312. The UAV travels with a velocity (speed and direction of motion), and the series of waypoints and velocities at that define the route with respect to time defines a trajectory of the UAV (at times referred to as a track of the UAV).

In accordance with example implementations, the MMS 210 is configured to receive instructions that describe the cleared path 304 the UAV 100 is authorized by the ANSP to travel through the airspace system. In some examples, the instructions may include other forms of clearances from the ANSP, which may be more tactical (e.g., hold altitude and heading), laterally strategic (e.g., follow the route lateral path), or vertically tactical (e.g., while holding altitude).

The MMS 210 is configured to determine guidance modes of the UAV 100 based on the instructions, the guidance modes indicating procedures of the UAV; and the MMS is configured to engage the guidance modes in which the UAV is caused to perform the procedures to carry out the flight. The MMS may determine and engage the guidance modes directly, or in some examples, the MMS may follow commands from the control station 202 at which the guidance modes are chosen.

Engagement of the guidance modes may include the MMS 210 or control station 202 configured to send one or more commands to the VMS 208 to control the UAV 100 to follow the commands and thereby execute respective maneuvers to carry out the guidance modes. In some examples, the MMS may be configured to provide a route, but the VMS may itself generate the commands to maneuver the route, such as using guidance, navigation and control (GNC) as part of the VMS.

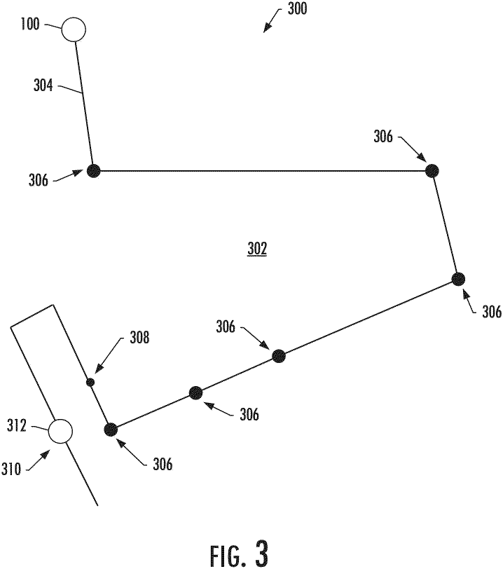

FIG. 4 illustrates various guidance modes 400 of the UAV 100, according to some example implementations of the present disclosure. As shown, the guidance modes include lateral flight modes 402 and vertical flight modes 404, that are subject to rules defined by the ANSP for travel through the airspace system under instrument flight rules (IFR), and the lateral flight modes and the vertical flight modes are separate and independent from one another. It should be understood, however, that some example implementations may also be applicable for travel under other rules, such as visual flight rules (VFR) defined by the ANSP.

In some examples, the flight of the UAV 100 is divided into phases including ground phases, air-ground transition phases, and an airborne phase, and one or more combinations of the lateral flight modes 402 and the vertical flight modes 404 are engaged as the UAV is in the airborne phase of the flight. In this regard, the guidance modes may be determined from built-in guidance modes including ground 406 modes for the ground phase, air-ground transition 408 modes for the air-ground transition phases, and airborne flight 410 modes for the airborne phase. The airborne flight modes may in turn include the lateral flight modes and the vertical flight modes.

Examples of suitable lateral flight modes 402 include a lateral navigation (LNAV) 412 mode, and further include track modes and heading modes. The track modes include track select (TRK SEL) 414 and track hold (TRK HLD) 416 modes, and the heading modes include heading select (HDG SEL) 418 and heading hold (HDG HLD) 420 modes. Suitable examples of vertical flight modes 404 include an altitude hold (ALT HLD) 422 mode, a flight-level change (FLCH) 424 mode, and a vertical speed (V/S) 426 mode. And in some examples, the vertical flight modes also include a vertical navigation (VNAV) 428 mode.

The airborne flight 410 modes may further include a lost-link 430 mode and an approach 432 mode. The lost-link mode in particular is engaged responsive to a lost-link event in which a datalink between the UAV 100 and a control station 202 is interrupted or lost.

The ground 406 modes may include a ground operations 434 mode, a taxi 436 mode and a line-up 438 mode; and the ground modes may also include a maintenance 440 mode. In some examples, the ground modes may further include an abort takeoff 442 mode. The air-ground transition 408 modes may include a takeoff 444 mode and a landing 446 mode.

In some examples, the guidance modes 400 have defined transitions, and the defined transitions include transitions of a number of different types such as a first type 448, a second type 450 and a third type 452. The first type of transition is from a first guidance mode to a second guidance mode in which the second guidance mode is engaged as the UAV 100 is in the first guidance mode to effect the transition, responsive to a request when a specified condition is fulfilled. In the second type of transition, the second guidance mode is engaged responsive to the request when the specified condition is fulfilled, and otherwise armed until the specified condition is fulfilled, at which time the second guidance mode is automatically engaged. In the third type of transition, the second guidance mode is automatically engaged to effect the transition when the specified condition is fulfilled. An additional, manual transition type of transition (reboot) may also be defined between the maintenance 440 mode and the ground operations 434 mode.

As shown for the ground 406 modes, for example, the defined transitions include transitions of the first type 448 between the ground operations 434 mode and the taxi 436 mode, and from the line-up 438 mode to the taxi mode. The defined transitions include transitions of the third type 452 from the takeoff 444 mode to the abort takeoff 442 mode, and from the abort takeoff mode to the taxi mode. The transitions from the line-up mode to the taxi mode, and from the takeoff mode ot the abort takeoff mode, in particular may be engaged when takeoff of the UAV 100 is rejected.

The defined transitions include transitions of the second type 450 from the taxi mode to the line-up mode, and from the line-up mode to the takeoff 444 mode. In some examples, both the line-up mode and the taxi mode may be engaged from the taxi mode, such as when given a “roll and go” instruction while the UAV 100 is on its last taxi leg. The defined transitions, then, may also include a transition of the third type from the takeoff mode to a combination of lateral flight mode 402 and vertical flight mode 404.

The defined transitions for the lateral flight modes 402 include transitions of the first type 448 between the track 414, 416 modes, between the heading 418, 420 modes, between the track modes and the heading modes, and from the lateral navigation mode 412 to the track modes and the heading modes. The defined transitions for the lateral flight modes also include transitions of the second type 450 from the track modes and the heading modes to the lateral navigation mode. For the vertical flight modes 404, the defined transitions include transitions of the first type between the vertical flight modes. The defined transitions may include transitions of the third type 452 from the flight-level change 424 mode and the vertical speed 426 mode to the altitude hold 422 mode, such as when the UAV 100 reaches a target altitude.

The defined transitions include a transition of the third type 452 from a combination of lateral flight mode 402 and vertical flight mode 404 to the lost-link 430 mode (responsive to a lost-link event). The defined transitions include a transition of the first type 448 from the lost-link mode to the combination of lateral flight mode and vertical flight mode when the datalink is recovered. And the defined transitions include a transition of the second type 450 from the lost-link mode to the approach 432 mode when the UAV 100 reaches an initial approach fix while still in the lost-link mode.

The defined transitions include a transition of the second type 450 from a combination of lateral flight mode 402 and vertical flight mode 404 to the approach 432 mode. The defined transitions include a transition of the second type from the approach 432 mode to the landing 446 mode. The defined transitions also include a transition of the first type 448 from the approach mode to the combination of lateral flight mode and vertical flight mode responsive to an aborted approach request. Similarly, the defined transitions include transitions of the third type 452 from the approach mode and the landing mode to a combination of lateral flight mode 402 and vertical flight mode 404 responsive to a missed approach, and from the approach mode and the landing mode to the lost-link 430 mode responsive to the missed approach during the lost-link event.

Again on the air-ground transition 408 and ground 406 modes, in some examples, the defined transitions include a transition of the third type 452 from the landing 446 mode to the taxi 436 mode, which may occur when the UAV 100 is clear of a runway at which it lands. The transitions of the third type may also include a transition from the taxi mode to the ground operations 434 mode. The transition from the taxi mode to the ground operations mode may be automatically engaged when the UAV 100 arrives at a parking location, which may be defined within a taxi route. The defined transitions may also include a transition of the first type 448 from the ground operations mode back to the taxi mode.

The Ground Modes. As described above, the guidance modes may include ground 406 modes such as a ground operations 434 mode, a maintenance 440 mode, a taxi 436 mode, a line-up 438 mode and an abort takeoff 442 mode. The ground operations mode may be the initial mode of the UAV 100 from power-on (boot mode) when on the ground. The ground operations mode may support safe handling during ground crew activities before a control station 202 connects (pre-flight), or after the control station disconnects (post-flight). The ground operations mode may also support control station / ground crew pre-flight and post-flight joint activities, including engine start / stop and control surface checks, prior to taxi. In the ground operations mode, the UAV may default to not accept engine start and control surface movement commands until a specific command is received to enable their acceptance.

Transition between the ground operations 434 mode and the maintenance 440 mode may be made via a hard switch on the UAV 100; and in the maintenance mode, connections to the UAV may be limited to maintenance personnel. The maintenance mode supports maintenance actions on the UAV such as those regarding software loading and testing. This may ensure that the UAV is unable to be connected to by a remote pilot or ground crew, and enable software to provide information regarding UAV configuration and the like.

In the taxi 436 mode, the UAV 100 executes a waypoint-based taxi route, and the UAV may accept a taxi route update (if consistent with the UAV’s current location on the taxiways). Each waypoint may include location (e.g., latitude / longitude) and an optional groundspeed constraint. Any groundspeed not specified may be defined by default. The groundspeed constraint for a waypoint may be zero, and when reaching this waypoint, the UAV 100 may stop and wait for a command from the control station 202 to proceed; and this command may be given when the ANSP clears the UAV to proceed. The UAV in the taxi mode may also accept a stop (or emergency stop) command at any point along the taxi route, after which the UAV may accept a command to resume ground travel on the taxi route. The stop command may be given by either the control station or the MMS 210, but the resume may be limited to the control station when the stop command is given by the control station.

The line-up 438 mode supports transition from taxi to takeoff; and in this mode, the UAV 100 may line up the UAV on a runway in preparation for takeoff. In this regard, the line-up mode may take the UAV from a runway hold short line to a runway centerline in preparation for takeoff. The line-up mode may be armed while the UAV is in the taxi 436 mode. This allows the UAV to enter the runway only when cleared by the ANSP. If not armed when taxi hits the runway hold short line, the UAV may stop and not enter the runway. Arming the line-up mode may also allow for a smooth transition from taxi to runway without stopping (or only briefly stopping), supporting effective clearance adherence.

In the abort takeoff 442 mode, the UAV 100 may decelerate down the runway, reduce to taxi speed on the runway, and then proceed to exit at a last runway exit, which may be known before takeoff. The UAV may transition from the abort takeoff mode back to the taxi mode in a similar manner as the UAV may transition from the landing 446 mode to the taxi mode (described below). The abort takeoff mode may be engaged automatically by the VMS 208 or requested by the control station 202. But the abort takeoff mode may be prevented from being engaged if the UAV is unable to safely abort the takeoff at the time a request is received from the control station.

The Air-Ground Transition Modes. The guidance modes may include air-ground 408 transition modes such as a takeoff 444 mode and a landing 446 mode. In the takeoff mode, the UAV 100 may accelerate down the runway, perform ground roll, and perform initial climb until the UAV is established in the air. When the UAV is established in the air, the UAV may automatically transition to a target combination of lateral flight mode 402 and vertical flight mode 404 based on an initial airborne clearance. This transition may occur automatically, without input from the control station 202. In some examples, the takeoff mode may be armed in taxi or line-up, when the line-up mode is armed. This may allow for a “roll and go” clearance from the ANSP.

In the landing 446 mode, the UAV 100 may execute a glideslope to a runway threshold, flare, and de-rotation while maintaining alignment with the runway course. The UAV may reduce to taxi speed when on runway and continue through runway exit. During this time, the UAV may be provided a default runway exit (default may be a final exit at the end of the runway). The UAV may accept runway exit updates while in the landing mode, and the UAV may be alerted if the current runway exit is unavailable, and fall back to a default exit. Runway exit information may include an initial taxi segment to first hold location along exit taxiway, which may enable the UAV to smoothly transition to the taxi 436 mode once exited. The UAV may automatically transition to the taxi mode when the UAV clears the runway, and the location of when to transition may be added to taxi exit information.

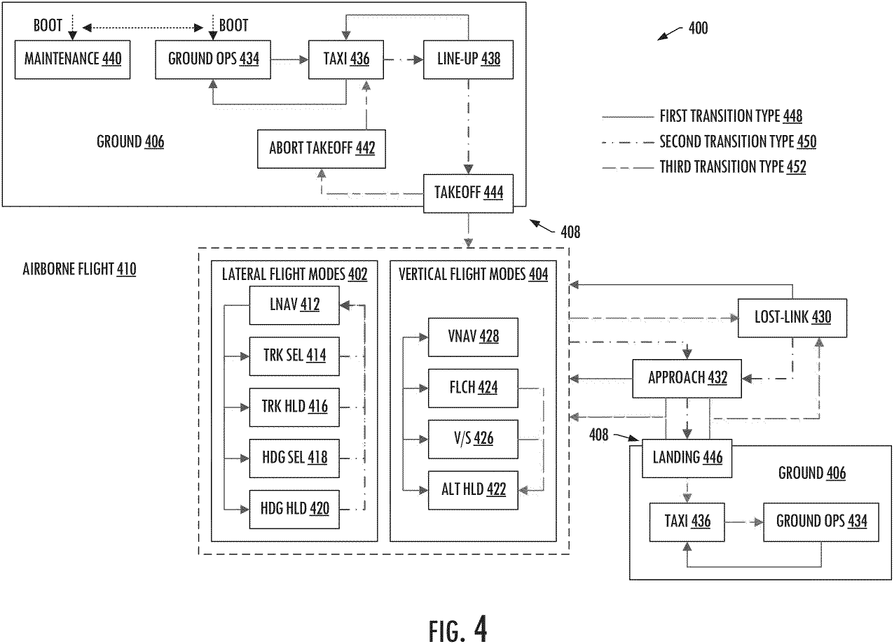

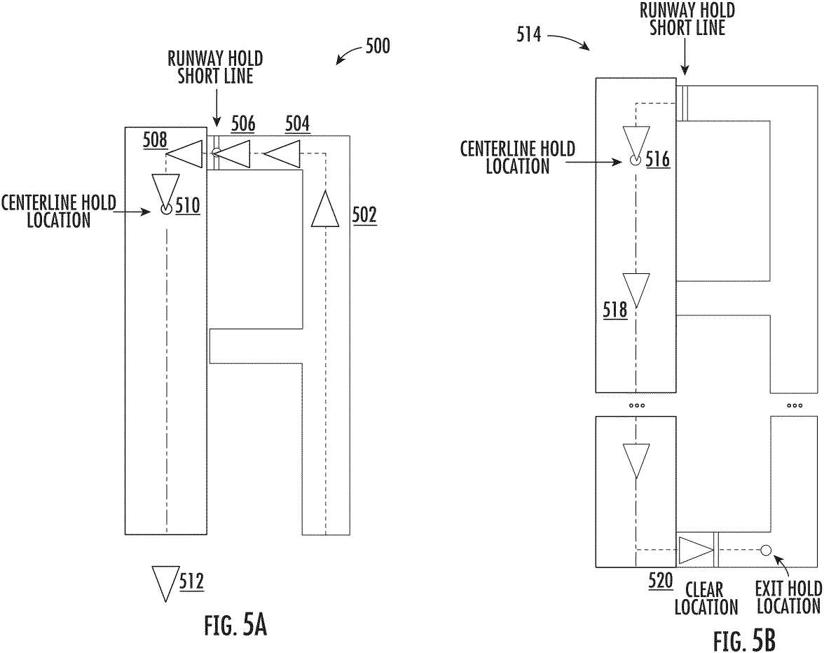

FIG. 5A illustrates a first scenario 500 in which various ground 406, air-ground transition 408 and airborne flight 410 modes are engaged, according to some example implementations. In the first scenario, these modes include the taxi 436, line-up 438 and takeoff 444 modes, and a combination of lateral flight mode 402 and vertical flight mode 404, are engaged. As shown at 502, the UAV 100 may operate in the taxi mode, and if no other mode is selected, the UAV may proceed to the runway hold short line and stop. When the line-up mode is selected at 504, it may arm but not engage until the UAV reaches the hold short line at 506. The UAV may here automatically engage the line-up mode; and if the takeoff mode is not selected, the UAV may proceed to the centerline hold location of the runway at 510 and stop. When the takeoff mode is selected at 508, the takeoff mode may be armed but not engage until the UAV reaches the centerline hold location at 510. The UAV may briefly stop at the centerline hold location, automatically engage the takeoff mode, and head down the runway. After takeoff, the UAV may transition to the combination of lateral flight mode 402 and vertical flight mode at 512.

FIG. 5B illustrates a second scenario 514 in which various ground 406 and air-ground 408 transition modes are engaged, according to some example implementations. In the first scenario, these modes include the takeoff 444, abort takeoff 442 and taxi 436 modes. As shown at 516, the UAV 100 may transition from the line-up 438 mode to the takeoff mode, and head down the runway, similar to the first scenario 500. A request to abort the takeoff may be received at 518, and the UAV may engage the abort takeoff mode, slow to taxi speed and proceed to exit at a last runway exit. The taxi mode may be automatically engaged when the UAV reaches a pre-defined clear of runway location at 520, and the UAV may continue to a pre-defined exit hold location.

The Airborne Flight Modes. The airborne flight 410 modes include the lateral flight modes 402, the vertical flight modes 404, and may further include an approach 432 mode, and a lost-link 430 mode. The lateral flight modes and the vertical flight modes are engaged in combinations of one lateral flight mode and one vertical flight mode. Other modes of the same type (vertical flight modes or lateral flight modes) may be configured for automatic transitions between the modes.

The lateral flight modes 402 may include a lateral navigation (LNAV) 412 mode, a track select (TRK SEL) 414 mode, a track hold (TRK HLD) 416 mode, a heading select (HDG SEL) 418 mode, and a heading hold (HDG HLD) 420 mode. In the lateral navigation mode, the UAV 100 may accept a set of waypoints, and follow a lateral path defined by the waypionts in route. The waypoints maybe developed based on published waypoints, procedures and the like for the airspace system 302, which may be filed with a flight plan. The waypoints may also include a holding pattern in which the UAV may automatically enter a holding pattern, and exit on request by the control station 202, or based on a pre-defined time or once around (for approach procedural turns). The lateral navigation mode may be engaged if currently armed, the UAV position is within a certain distance of a leg, and its current course is within a certain degrees of a direction along that leg at the time the mode is activated; and the lateral navigation mode may remain engaged until a new lateral flight mode is selected.

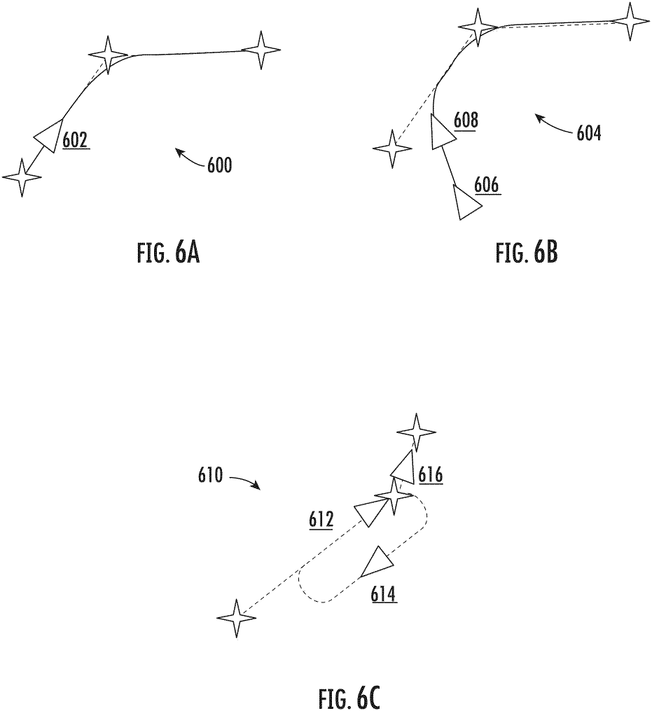

FIGS. 6A-6C illustrate the UAV 100 in the lateral navigation 412 mode over three scenarios, according to some example implementations. FIG. 6A illustrates a first scenario 600 in which the lateral navigation mode may engage when selected at 602, if within a certain distance and course requirement of a route leg. In FIG. 6B for a second scenario 604, the UAV may be in the heading hold 420 mode at 606, with the lateral navigation mode armed but not engaged with the UAV outside the certain distance requirement of a route leg to engage. The UAV may then autoamtically engage the lateral navigation mode when, at 608, the UAV reaches the distance requirement of the route leg (as well as the course requirement).

In FIG. 6C for the third scenario 610, the UAV 100 may be operating in the lateral navigation 412 mode when, at 612, the UAV encounters a holding pattern defined at a waypoint, and the UAV initiates the hold. The UAV may continue to hold at 614, following the holding pattern until the UAV receives input from the control station 202, or after a pre-defined time during a lost-link event. The UAV may then exit the hold at 616, following an accepted procedure defined by the ANSP.

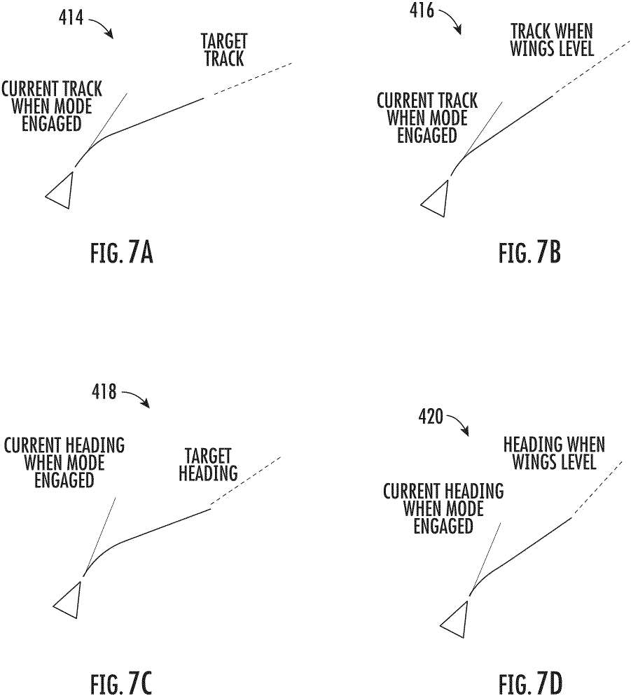

Turning now to other lateral flight modes 402, in the track select 414 mode, the UAV 100 may accept a target track, and turn to and maintain the target track (true ground course), as shown in FIG. 7A. In the track hold 416 mode, the UAV 100 may maintain its current track (true ground course) at the time the mode is engaged, as shown in FIG. 7B. If the UAV is turning when this mode is engaged, the track may be achieved after the UAV regains a level position. FIGS. 7C and 7D illustrate the heading select 418 and heading hold 420 modes, in which the UAV may operate similar to the track modes but with respect to a magnetic heading instead of a track. Each of these track and heading modes may be engaged when selected, and remain engaged until a new lateral flight mode 402 is selected.

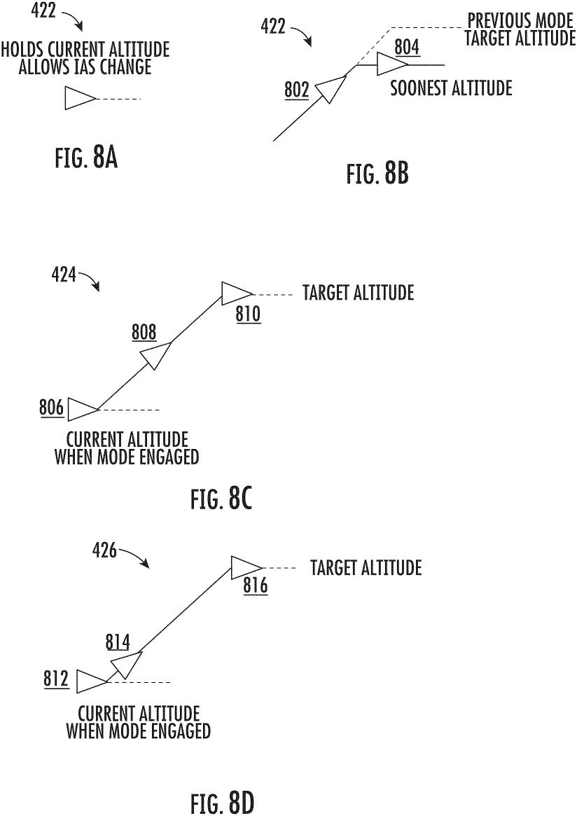

The vertical flight modes 404 may include an altitude hold (ALT HLD) 422 mode, a flight-level change (FLCH) 424 mode, and a vertical speed (V/S) 426 mode. In the altitude hold mode, the UAV 100 may maintain its current altitude. The UAV may also accept a target airspeed (e.g., indicated airspeed - IAS), which allows adjustment of the UAV’s airspeed in this mode; otherwise, the UAV may maintain its current airspeed. FIG. 8A illustrates the altitude hold mode in one example. FIG. 8B illustrates the altitude hold in another example in which the UAV is climbing when the mode is engaged at 802, in which case the UAV may level off to an altitude at 804 that the UAV may then maintain.

In the flight-level change 424 mode, the UAV 100 may accept a target altitude, and climb or descend to the target altitude. Similar to the altitude hold 422 mode, the UAV may also accept a target airspeed in the flight-level change mode, which may also allow adjustment of the UAV’s airspeed in the flight-level change mode. The flight-level change mode may be engaged when selected, and with selection of the flight-level change mode. As shown in FIG. 8C, the UAV may transition to the flight-level change mode at 806. The UAV climbs at 808 to the target altitude at 810, where the UAV then transitions to and engages the altitude hold mode.

In the vertical speed 426 mode, the UAV 100 may accept a target altitude and a target altitude rate; and again, the UAV may also accept a target airspeed. The UAV may then climb or descend to the target altitude at the target altitude rate, while maintaining the target airspeed (or its current airspeed). Similar to the flight-level change 424 mode, the vertical speed mode may be engaged when selected, and with selection of the flight-level change mode. As shown in FIG. 8D, the UAV may transition to the vertical speed mode at 812. The UAV climbs at the target altitude rate at 814 to the target altitude at 816, where the UAV then transitions to and engages the altitude hold mode.

As explained above, the lost-link 430 mode may be engaged responsive to a lost-link event in which a datalink between the UAV 100 and a control station 202 is interrupted or lost. In this mode, the UAV may follow a lost-link procedure, including any delays in execution from existing clearances and any pre-defined holding points. An approach, runway, default exit clearance and the like may be assigned based on the lost link procedure. The approach 432 and landing 446 modes may be armed when the lost-link mode is engaged so that those modes will engage when appropriate. In some examples, the lost-link procedure may get the UAV to the IAF, at which point the UAV may transition to the approach mode.

In the approach 432 mode, the UAV 100 may execute a target approach procedure defined by lateral waypoints with or without vertical altitude constraints and glideslope, and the approach procedure may be provided prior to mode being requested. The approach mode may engage when the UAV intercepts a lateral path defined by the approach procedure, between an initial approach fix (IAF) and a final approach fix (FAF). The current course of the UAV may be consistent with turning onto an approach lateral path, and the UAV’s altitude may be consistent with altitude constraints (if any) and glideslope. If the UAV is unable to engage the approach mode, the mode may be armed until it may be engaged. It may sometimes be the case that, while in the approach mode, the UAV reaches a missed approach point (MAP) without receiving a landing clearance. In this case, the UAV may automatically switch to an appropriate combination of lateral flight mode 402 and vertical flight mode 404, and execute a missed approach procedure.

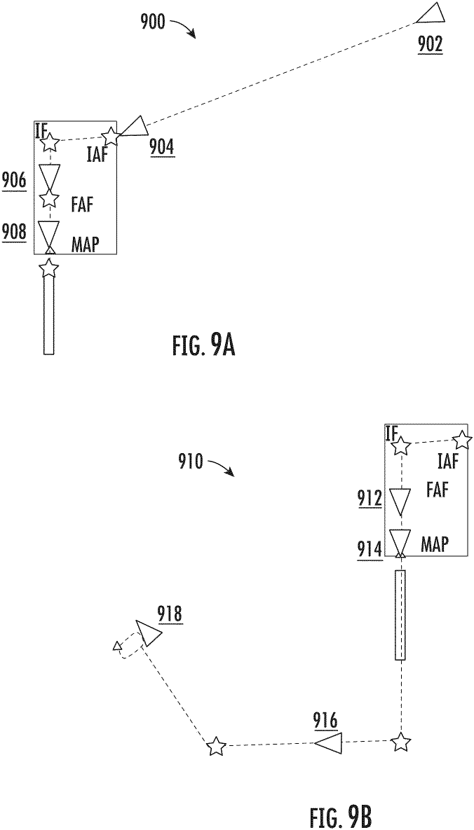

FIG. 9A illustrates a first scenario 900 including the approach 432 mode to landing, according to some example implementations. As shown at 902, the UAV 100 may be operating in a combination of lateral flight mode 402 and vertical flight mode 404, and the approach mode may be armed when an approach clearance is received. The approach mode may be engaged at 904 when certain conditions are met, such has the UAV is within a certain distance of the IAF, and at a certain altitude. In the approach mode, the UAV may follow lateral and vertical (altitude / airspeed) constraints, and transition to glideslope at the FAF, as shown at 906. Here, the UAV may select the landing 446 mode, which may arm the landing mode when a landing clearance is received, and until conditions are met for the UAV to engage the landing mode. While the landing mode is armed, the UAV may continue past the MAP at 908 until the landing mode engages.

FIG. 9B illustrates a second scenario 910 including the approach 432 mode to a missed approach, according to some example implementations. In this scenario, the UAV 100 may be operating in the approach mode at 912, but without a landing clearance, the landing 446 mode may not be armed. Then when the UAV reaches the MAP at 914 without the landing mode armed, the UAV may engage the appropriate combination of lateral flight mode 402 and vertical flight mode 404, and execute a missed approach procedure at 916 and 918.

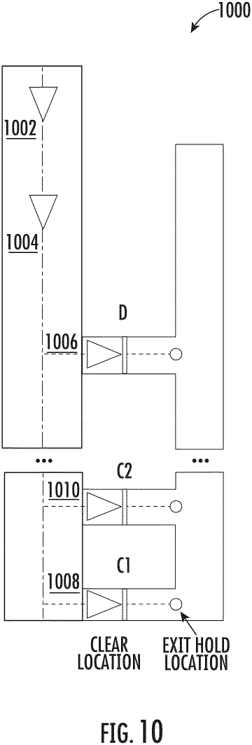

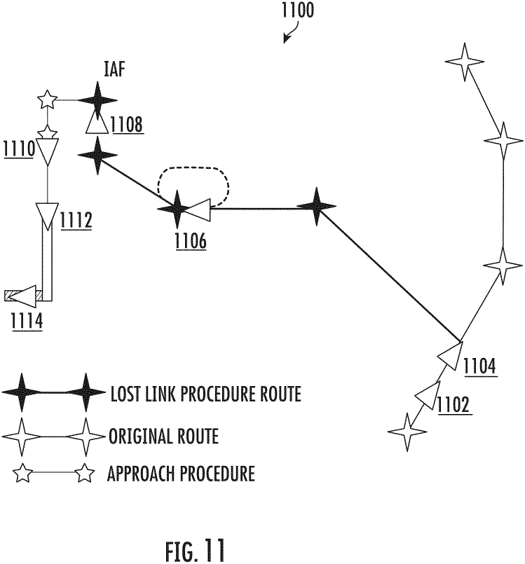

FIG. 10 illustrates a scenario 1000 in which the landing 446 and taxi 436 modes are engaged, according to some example implementations. As shown at 1002, the UAV 100 is operating in the landing 446 mode in which the UAV may execute a landing procedure, including flare, de-rotation and reduction to taxi speed. As the landing procedure is executed, the UAV may receive a taxi exit clearance from the control station 202 at 1004. The UAV may identify if a cleared runway exit D is achievable, and exit at the cleared runway exit at 1006 when able. If the cleared runway exit is not achievable, the UAV may proceed to a last runway exit C1 at 1008, unless the UAV receives information that indicates another runway exit C2 is achievable for the UAV to exit at 1010. The UAV may exit the runway, and transition to the taxi mode when the UAV reaches a predefined clear of runway location, and continue to an exit hold location if no taxi clearance is received before the UAV reaches that location.

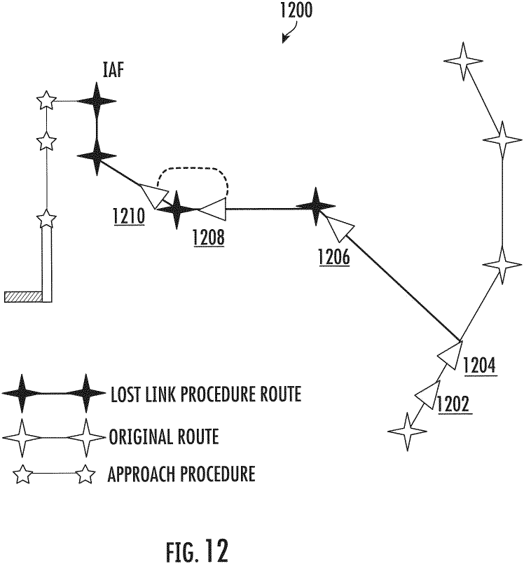

FIGS. 11 and 12 illustrate scenarios 1100 and 1200 in which various airborne flight 410, air-ground transition 408, and ground 406 modes are engaged, according to some example implementations. As shown at 1102 of scenario 1100, the UAV 100 may be operating in a combination of lateral flight mode 402 and vertical flight mode 404, and detect a lost-link event in which a datalink between the UAV 100 and a control station 202 is interrupted or lost. The UAV may identify a lost-link route and information that indicates when to execute the the lost-link route. The lost-link 430 mode may be automatically engaged at 1104, and the lost-link route may be executed according to a lost-link procedure. Information may be identified for approach and landing, and both the approach 432 and landing 446 modes may be armed. As shown at 1106, the UAV may perform built-in altitude changes at specified waypoints and holding patterns (prescribed time in hold), which may be identified by waypoint constraints.

The UAV 100 may automatically engage the approach 432 mode at the IAF, as shown at 1108; and since the landing 446 mode is armed, the UAV may proceed past the MAP at 1110. The landing mode may be automatically engaged at 1112, and the UAV may exit the runway at a default runway exit (e.g., end of runway). The UAV may automatically transition to the taxi 436 mode, and proceed to a first hold point at an end of the runway exit, as shown at 1114.

In FIG. 12, scenario 1200 may at first be similar to scenario 1100. That is, the UAV 100 may be operating in a combination of lateral flight mode 402 and vertical flight mode 404, and detect a lost-link event, as shown at 1202. The UAV may identify a lost-link route and information that indicates when to execute the the lost-link route. The lost-link 430 mode may be automatically engaged at 1204, and the lost-link route to a diversion airport may be executed according to the lost-link procedure. Information may be identified for approach and landing, and both the approach 432 and landing 446 modes may be armed. As shown at 1206, the UAV may perform built-in altitude changes at specified waypoints and holding patterns (prescribed time in hold), which may be identified by waypoint constraints.

In scenario 1200, the datalink between the UAV 100 and a control station 202 may be recovered at 1208. The approach 432 and landing 446 modes may be disarmed. The UAV may remain in the lost-link mode, and the control station 202 may contact the ANSP for a clearance update. Then at 1210, the control station may update the guidance modes based on clearances from the ANSP, and transition the UAV out of the lost-link mode. The clearances from the ANSP may indicate whether the UAV continues to a diversion airport or diverts again back to its original destination airport.

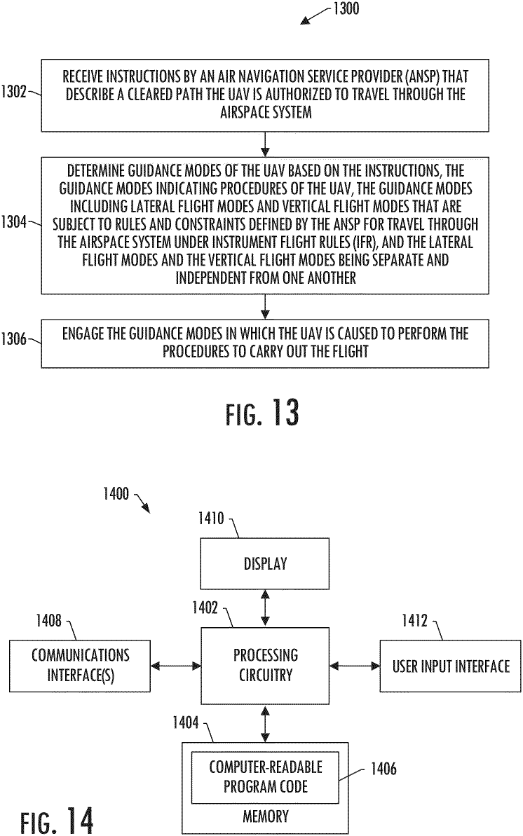

FIG. 13 is a flowchart illustrating various steps in a method 1300 of supporting operations of an unmanned air vehicle (UAV) on a flight in an airspace system, according to various example implementations of the present disclosure. The method includes receiving instructions that describe a cleared path the UAV is authorized by an air navigation service provider (ANSP) to travel through the airspace system, as shown at block 1302. The method includes determining guidance modes of the UAV based on the instructions, as shown at block 1304. The guidance modes indicate procedures of the UAV. The guidance modes include a number of different modes, such as lateral flight modes and vertical flight modes, that are subject to rules defined by the ANSP for travel through the airspace system under instrument flight rules (IFR). In this regard, the lateral flight modes and the vertical flight modes are separate and independent from one another. And the method includes engaging the guidance modes in which the UAV is caused to perform the procedures to carry out the flight, as shown at block 1306.

In some examples, the lateral flight modes include a lateral navigation mode, and further include track modes and heading modes. In some of these examples, the track modes include track select and track hold modes, and the heading modes include heading select and heading hold modes.

In some examples, the vertical flight modes include an altitude hold mode, a flight-level change mode, and a vertical speed mode.

In some examples, the vertical flight modes also include a vertical navigation (VNAV) mode.

In some examples, the flight of the UAV is divided into phases including ground phases, air-ground transition phases, and an airborne phase, and one or more combinations of the lateral flight modes and the vertical flight modes are engaged at block 1306 as the UAV is in the airborne phase of the flight.

In some examples, the guidance modes are determined at block 1304 from built-in guidance modes including airborne flight modes for an airborne phase of the flight, and the airborne flight modes the include the lateral flight modes and the vertical flight modes.

In some examples, the airborne flight modes further include a lost-link mode and an approach mode, the lost-link mode engaged at block 1306 responsive to a lost-link event in which a datalink between the UAV and a control station is interrupted or lost.

In some examples, the built-in guidance modes further include ground modes for a ground phase of the flight, and air-ground transition modes for air-ground transition phases of the flight. In some of these examples, the ground modes include a ground operations mode, a taxi mode, and a line-up mode, and the air-ground transition modes include a takeoff mode and a landing mode. In some examples, the ground modes further include an abort takeoff mode.

In some examples, the guidance modes have defined transitions, and the defined transitions include a first type of transition from a first guidance mode to a second guidance mode in which the second guidance mode is engaged at block 1306 as the UAV is in the first guidance mode to effect the transition, responsive to a request when a specified condition is fulfilled.

In some examples, the defined transitions include a second type of transition in which the second guidance mode is engaged at block 1306 responsive to the request when the specified condition is fulfilled, and otherwise armed until the specified condition is fulfilled, at which time the second guidance mode is automatically engaged.

In some examples, the guidance modes further include a ground operations mode, a taxi mode, a line-up mode, and a takeoff mode. In some of these examples, the defined transitions include transitions of the first type between the ground operations mode and the taxi mode, and from the line-up mode to the taxi mode, and the defined transitions include transitions of the second type from the taxi mode to the line-up mode, and from the line-up mode to the takeoff mode.

In some examples, the lateral flight modes include a lateral navigation mode, and further include track modes and heading modes. In some of these examples, the defined transitions include transitions of the first type between the track modes, between the heading modes, between the track modes and the heading modes, and from the lateral navigation mode to the track modes and the heading modes, and the defined transitions include transitions of the second type from the track modes and the heading modes to the lateral navigation mode.

In some examples, the guidance modes further include an approach mode, and the defined transitions include a transition of the second type from a combination of lateral flight mode and vertical flight mode to the approach mode, and a transition of the first type from the approach mode to the combination of lateral flight mode and vertical flight mode responsive to an aborted approach request.

In some examples, the guidance modes further include a landing mode, and the defined transitions include a transition of the second type from the approach mode to the landing mode.

In some examples, the guidance modes further include a lost-link mode and an approach mode, the lost-link mode engaged at block 1306 responsive to a lost-link event in which a datalink between the UAV and a control station is interrupted or lost. In some of these examples, the defined transitions include a transition of the first type from the lost-link mode to a combination of lateral flight mode and vertical flight mode when the datalink is recovered, and a transition of the second type from the lost-link mode to the approach mode when the UAV reaches an initial approach fix while still in the lost-link mode.

In some examples, the defined transitions include a third type of transition from a first guidance mode to a second guidance mode in which the second guidance mode is automatically engaged at block 1306 to effect the transition when the specified condition is fulfilled.

In some examples, the guidance modes further include a takeoff mode, and the defined transitions include a transition of the third type from the takeoff mode to a combination of lateral flight mode and vertical flight mode.

In some examples, the guidance modes further include a taxi mode and an abort takeoff mode, and the defined transitions include transitions of the third type from the takeoff mode to the abort takeoff mode, and from the abort takeoff mode to the taxi mode.

In some examples, the vertical flight modes include an altitude hold mode, a flight-level change mode, and a vertical speed mode. In some of these examples, the defined transitions include transitions of the first type between the vertical flight modes, and transitions of the third type from the flight-level change mode and the vertical speed mode to the altitude hold mode. In some examples, the vertical flight modes also include a vertical navigation (VNAV) mode, and the defined transitions include transitions of the first type between the VNAV mode and others of the vertical flight modes.

In some examples, the guidance modes further include a lost-link mode that is engaged responsive to a lost-link event in which a datalink between the UAV and a control station is interrupted or lost. In some of these examples, the defined transitions include a transition of the third type from a combination of lateral flight mode and vertical flight mode to the lost-link mode, and a transition of the first type from the lost-link mode to the combination of lateral flight mode and vertical flight mode when the datalink is recovered.

In some examples, the guidance modes further include a lost-link mode, an approach mode and a landing mode, the lost-link mode engaged responsive to a lost-link event in which a datalink between the UAV and a control station is interrupted or lost. In some of these examples, the defined transitions include transitions of the third type from the approach mode and the landing mode to a combination of lateral flight mode and vertical flight mode responsive to a missed approach, and from the approach mode and the landing mode to the lost-link mode responsive to the missed approach during the lost-link event.

In some examples, the guidance modes further include a landing mode, a taxi mode and a ground operations mode. In some of these examples, the defined transitions include transitions of the third type from the landing mode to the taxi mode, and from the taxi mode to the ground operations mode, and the defined transitions include a transition of the first type from the ground operations mode to the taxi mode.

According to example implementations of the present disclosure, the VMS 208 and the MMS210 may be implemented by various means. Means for implementing the VMS and MMSmay include hardware, alone or under direction of one or more computer programs from a computer-readable storage medium. In some examples, one or more apparatuses may be configured to function as or otherwise implement the VMS and MMSshown and described herein. In examples involving more than one apparatus, the respective apparatuses may be connected to or otherwise in communication with one another in a number of different manners, such as directly or indirectly via a wired or wireless network or the like.

FIG. 14 illustrates an apparatus 1400 according to some example implementations of the present disclosure. Generally, an apparatus of exemplary implementations of the present disclosure may comprise, include or be embodied in one or more fixed or portable electronic devices. The apparatus may include one or more of each of a number of components such as, for example, processing circuitry 1402 (e.g., processor unit) connected to a memory 1404 (e.g., storage device).

The processing circuitry 1402 may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 1404 (of the same or another apparatus).

The processing circuitry 1402 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 1404 is generally any piece of computer hardware that is capable of storing information such as, for example, data, computer programs (e.g., computer-readable program code 1406) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk - read only memory (CD-ROM), compact disk - read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 1404, the processing circuitry 1402 may also be connected to one or more interfaces for displaying, transmitting and/or receiving information. The interfaces may include a communications interface 1408 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 1410 and/or one or more user input interfaces 1412 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 1400 may include a processing circuitry 1402 and a computer-readable storage medium or memory 1404 coupled to the processing circuitry, where the processing circuitry is configured to execute computer-readable program code 1406 stored in the memory. It will also be understood that one or more functions, and combinations of functions, may be implemented by special purpose hardware-based computer systems and/or processing circuitry which perform the specified functions, or combinations of special purpose hardware and program code instructions.

As explained above and reiterated below, the present disclosure includes, without limitation, the following example implementations.

Clause 1. An apparatus for supporting operations of an unmanned air vehicle (UAV) on a flight in an airspace system, the apparatus comprising: a memory configured to store computer-readable program code; and processing circuitry configured to access the memory, and execute the computer-readable program code to cause the apparatus to at least: receive instructions that describe a cleared path the UAV is authorized by an air navigation service provider (ANSP) to travel through the airspace system; determine guidance modes of the UAV based on the instructions, the guidance modes indicating procedures of the UAV, the guidance modes including lateral flight modes and vertical flight modes, that are subject to rules defined by the ANSP for travel through the airspace system under instrument flight rules (IFR), and the lateral flight modes and the vertical flight modes being separate and independent from one another; and engage the guidance modes in which the UAV is caused to perform the procedures to carry out the flight.

Clause 2. The apparatus of clause 1, wherein the lateral flight modes include a lateral navigation mode, and further include track modes and heading modes, and wherein the track modes include track select and track hold modes, and the heading modes include heading select and heading hold modes.

Clause 3. The apparatus of clause 1 or clause 2, wherein the vertical flight modes include an altitude hold mode, a flight-level change mode, and a vertical speed mode.

Clause 4. The apparatus of any of clauses 1 to 3, wherein the flight of the UAV is divided into phases including ground phases, air-ground transition phases, and an airborne phase, and one or more combinations of the lateral flight modes and the vertical flight modes are engaged as the UAV is in the airborne phase of the flight.

Clause 5. The apparatus of any of clauses 1 to 4, wherein the guidance modes are determined from built-in guidance modes including airborne flight modes for an airborne phase of the flight, and the airborne flight modes the include the lateral flight modes and the vertical flight modes.

Clause 6. The apparatus of clause 5, wherein the airborne flight modes further include a lost-link mode and an approach mode, the lost-link mode engaged responsive to a lost-link event in which a datalink between the UAV and a control station is interrupted or lost.

Clause 7. The apparatus of clause 5 or clause 6, wherein the built-in guidance modes further include ground modes for a ground phase of the flight, and air-ground transition modes for air-ground transition phases of the flight, and wherein the ground modes include a ground operations mode, a taxi mode, and a line-up mode, and the air-ground transition modes include a takeoff mode and a landing mode.

Clause 8. The apparatus of any of clauses 1 to 7, wherein the guidance modes have defined transitions, and the defined transitions include a first type of transition from a first guidance mode to a second guidance mode in which the second guidance mode is engaged as the UAV is in the first guidance mode to effect the transition, responsive to a request when a specified condition is fulfilled.

Clause 9. The apparatus of clause 8, wherein the defined transitions include a second type of transition in which the second guidance mode is engaged responsive to the request when the specified condition is fulfilled, and otherwise armed until the specified condition is fulfilled, at which time the second guidance mode is automatically engaged.

Clause 10. The apparatus of clause 9, wherein the guidance modes further include a ground operations mode, a taxi mode, a line-up mode, and a takeoff mode, and wherein the defined transitions include transitions of the first type between the ground operations mode and the taxi mode, and from the line-up mode to the taxi mode, and the defined transitions include transitions of the second type from the taxi mode to the line-up mode, and from the line-up mode to the takeoff mode.

Clause 11. The apparatus of clause 9 or clause 10, wherein the lateral flight modes include a lateral navigation mode, and further include track modes and heading modes, and wherein the defined transitions include transitions of the first type between the track modes, between the heading modes, between the track modes and the heading modes, and from the lateral navigation mode to the track modes and the heading modes, and the defined transitions include transitions of the second type from the track modes and the heading modes to the lateral navigation mode.

Clause 12. The apparatus of any of clauses 9 to 11, wherein the guidance modes further include an approach mode, and the defined transitions include a transition of the second type from a combination of lateral flight mode and vertical flight mode to the approach mode, and a transition of the first type from the approach mode to the combination of lateral flight mode and vertical flight mode responsive to an aborted approach request.

Clause 13. The apparatus of clause 12, wherein the guidance modes further include a landing mode, and the defined transitions include a transition of the second type from the approach mode to the landing mode.

Clause 14. The apparatus of any of clauses 9 to 13, wherein the guidance modes further include a lost-link mode and an approach mode, the lost-link mode engaged responsive to a lost-link event in which a datalink between the UAV and a control station is interrupted or lost, and wherein the defined transitions include a transition of the first type from the lost-link mode to a combination of lateral flight mode and vertical flight mode when the datalink is recovered, and a transition of the second type from the lost-link mode to the approach mode when the UAV reaches an initial approach fix while still in the lost-link mode.

Clause 14. The apparatus of any of clauses 8 to 14, wherein the defined transitions include a third type of transition from a first guidance mode to a second guidance mode in which the second guidance mode is automatically engaged to effect the transition when the specified condition is fulfilled.

Clause 16. The apparatus of clause 14, wherein the guidance modes further include a takeoff mode, and the defined transitions include a transition of the third type from the takeoff mode to a combination of lateral flight mode and vertical flight mode.

Clause 17. The apparatus of clause 16, wherein the guidance modes further include a taxi mode and an abort takeoff mode, and the defined transitions include transitions of the third type from the takeoff mode to the abort takeoff mode, and from the abort takeoff mode to the taxi mode.

Clause 19. The apparatus of any of clauses 14 to 18, wherein the vertical flight modes include an altitude hold mode, a flight-level change mode, and a vertical speed mode, and wherein the defined transitions include transitions of the first type between the vertical flight modes, and transitions of the third type from the flight-level change mode and the vertical speed mode to the altitude hold mode.

Clause 20. The apparatus of any of clauses 14 to 19, wherein the guidance modes further include a lost-link mode that is engaged responsive to a lost-link event in which a datalink between the UAV and a control station is interrupted or lost, and wherein the defined transitions include a transition of the third type from a combination of lateral flight mode and vertical flight mode to the lost-link mode, and a transition of the first type from the lost-link mode to the combination of lateral flight mode and vertical flight mode when the datalink is recovered.

Clause 21. The apparatus of any of clauses 14 to 20, wherein the guidance modes further include a lost-link mode, an approach mode and a landing mode, the lost-link mode engaged responsive to a lost-link event in which a datalink between the UAV and a control station is interrupted or lost, and wherein the defined transitions include transitions of the third type from the approach mode and the landing mode to a combination of lateral flight mode and vertical flight mode responsive to a missed approach, and from the approach mode and the landing mode to the lost-link mode responsive to the missed approach during the lost-link event.

Clause 22. The apparatus of any of clauses 14 to 21, wherein the guidance modes further include a landing mode, a taxi mode and a ground operations mode, and wherein the defined transitions include transitions of the third type from the landing mode to the taxi mode, and from the taxi mode to the ground operations mode, and the defined transitions include a transition of the first type from the ground operations mode to the taxi mode.

Clause 23. A method of supporting operations of an unmanned air vehicle (UAV) on a flight in an airspace system, the method comprising: receiving instructions that describe a cleared path the UAV is authorized by an air navigation service provider (ANSP) to travel through the airspace system; determining guidance modes of the UAV based on the instructions, the guidance modes indicating procedures of the UAV, the guidance modes including lateral flight modes and vertical flight modes, that are subject to rules defined by the ANSP for travel through the airspace system under instrument flight rules (IFR), and the lateral flight modes and the vertical flight modes being separate and independent from one another; and engaging the guidance modes in which the UAV is caused to perform the procedures to carry out the flight.

Clause 24. The method of clause 23, wherein the lateral flight modes include a lateral navigation mode, and further include track modes and heading modes, and wherein the track modes include track select and track hold modes, and the heading modes include heading select and heading hold modes.

Clause 25. The method of clause 23 or clause 24, wherein the vertical flight modes include an altitude hold mode, a flight-level change mode, and a vertical speed mode.

Clause 26. The method of any of clauses 23 to 25, wherein the flight of the UAV is divided into phases including ground phases, air-ground transition phases, and an airborne phase, and one or more combinations of the lateral flight modes and the vertical flight modes are engaged as the UAV is in the airborne phase of the flight.

Clause 27. The method of any of clauses 23 to 26, wherein the guidance modes are determined from built-in guidance modes including airborne flight modes for an airborne phase of the flight, and the airborne flight modes the include the lateral flight modes and the vertical flight modes.

Clause 28. The method of clause 27, wherein the airborne flight modes further include a lost-link mode and an approach mode, the lost-link mode engaged responsive to a lost-link event in which a datalink between the UAV and a control station is interrupted or lost.

Clause 29. The method of clause 27 or clause 28, wherein the built-in guidance modes further include ground modes for a ground phase of the flight, and air-ground transition modes for air-ground transition phases of the flight, and wherein the ground modes include a ground operations mode, a taxi mode, and a line-up mode, and the air-ground transition modes include a takeoff mode and a landing mode.

Clause 30. The method of any of clauses 23 to 29, wherein the guidance modes have defined transitions, and the defined transitions include a first type of transition from a first guidance mode to a second guidance mode in which the second guidance mode is engaged as the UAV is in the first guidance mode to effect the transition, responsive to a request when a specified condition is fulfilled.

Clause 31. The method of clause 30, wherein the defined transitions include a second type of transition in which the second guidance mode is engaged responsive to the request when the specified condition is fulfilled, and otherwise armed until the specified condition is fulfilled, at which time the second guidance mode is automatically engaged.

Clause 32. The method of clause 31, wherein the guidance modes further include a ground operations mode, a taxi mode, a line-up mode, and a takeoff mode, and wherein the defined transitions include transitions of the first type between the ground operations mode and the taxi mode, and from the line-up mode to the taxi mode, and the defined transitions include transitions of the second type from the taxi mode to the line-up mode, and from the line-up mode to the takeoff mode.

Clause 33. The method of clause 31 or clause 32, wherein the lateral flight modes include a lateral navigation mode, and further include track modes and heading modes, and wherein the defined transitions include transitions of the first type between the track modes, between the heading modes, between the track modes and the heading modes, and from the lateral navigation mode to the track modes and the heading modes, and the defined transitions include transitions of the second type from the track modes and the heading modes to the lateral navigation mode.

Clause 34. The method of any of clauses 31 to 33, wherein the guidance modes further include an approach mode, and the defined transitions include a transition of the second type from a combination of lateral flight mode and vertical flight mode to the approach mode, and a transition of the first type from the approach mode to the combination of lateral flight mode and vertical flight mode responsive to an aborted approach request.

Clause 35. The method of clause 34, wherein the guidance modes further include a landing mode, and the defined transitions include a transition of the second type from the approach mode to the landing mode.

Clause 36. The method of any of clauses 31 to 35, wherein the guidance modes further include a lost-link mode and an approach mode, the lost-link mode engaged responsive to a lost-link event in which a datalink between the UAV and a control station is interrupted or lost, and wherein the defined transitions include a transition of the first type from the lost-link mode to a combination of lateral flight mode and vertical flight mode when the datalink is recovered, and a transition of the second type from the lost-link mode to the approach mode when the UAV reaches an initial approach fix while still in the lost-link mode.

Clause 37. The method of any of clauses 30 to 36, wherein the defined transitions include a third type of transition from a first guidance mode to a second guidance mode in which the second guidance mode is automatically engaged to effect the transition when the specified condition is fulfilled.

Clause 38. The method of clause 37, wherein the guidance modes further include a takeoff mode, and the defined transitions include a transition of the third type from the takeoff mode to a combination of lateral flight mode and vertical flight mode.

Clause 39. The method of clause 38, wherein the guidance modes further include a taxi mode and an abort takeoff mode, and the defined transitions include transitions of the third type from the takeoff mode to the abort takeoff mode, and from the abort takeoff mode to the taxi mode.

Clause 41. The method of any of clauses 37 to 40, wherein the vertical flight modes include an altitude hold mode, a flight-level change mode, and a vertical speed mode, and wherein the defined transitions include transitions of the first type between the vertical flight modes, and transitions of the third type from the flight-level change mode and the vertical speed mode to the altitude hold mode.

Clause 42. The method of any of clauses 37 to 41, wherein the guidance modes further include a lost-link mode that is engaged responsive to a lost-link event in which a datalink between the UAV and a control station is interrupted or lost, and wherein the defined transitions include a transition of the third type from a combination of lateral flight mode and vertical flight mode to the lost-link mode, and a transition of the first type from the lost-link mode to the combination of lateral flight mode and vertical flight mode when the datalink is recovered.

Clause 43. The method of any of clauses 37 to 42, wherein the guidance modes further include a lost-link mode, an approach mode and a landing mode, the lost-link mode engaged responsive to a lost-link event in which a datalink between the UAV and a control station is interrupted or lost, and wherein the defined transitions include transitions of the third type from the approach mode and the landing mode to a combination of lateral flight mode and vertical flight mode responsive to a missed approach, and from the approach mode and the landing mode to the lost-link mode responsive to the missed approach during the lost-link event.

Clause 44. The method of any of clauses 37 to 43, wherein the guidance modes further include a landing mode, a taxi mode and a ground operations mode, and wherein the defined transitions include transitions of the third type from the landing mode to the taxi mode, and from the taxi mode to the ground operations mode, and the defined transitions include a transition of the first type from the ground operations mode to the taxi mode.

Clause 45. A computer-readable storage medium for supporting operations of an unmanned air vehicle (UAV) on a flight in an airspace system, the computer-readable storage medium being non-transitory and having computer-readable program code stored therein that, in response to execution by processing circuitry, causes an apparatus to at least: receive instructions that describe a cleared path the UAV is authorized by an air navigation service provider (ANSP) to travel through the airspace system; determine guidance modes of the UAV based on the instructions, the guidance modes indicating procedures of the UAV, the guidance modes including lateral flight modes and vertical flight modes, that are subject to rules defined by the ANSP for travel through the airspace system under instrument flight rules (IFR), and the lateral flight modes and the vertical flight modes being separate and independent from one another; and engage the guidance modes in which the UAV is caused to perform the procedures to carry out the flight.

Clause 46. The computer-readable storage medium of clause 45, wherein the lateral flight modes include a lateral navigation mode, and further include track modes and heading modes, and wherein the track modes include track select and track hold modes, and the heading modes include heading select and heading hold modes.

Clause 47. The computer-readable storage medium of clause 45 or clause 46, wherein the vertical flight modes include an altitude hold mode, a flight-level change mode, and a vertical speed mode.

Clause 48. The computer-readable storage medium of any of clauses 45 to 47, wherein the flight of the UAV is divided into phases including ground phases, air-ground transition phases, and an airborne phase, and one or more combinations of the lateral flight modes and the vertical flight modes are engaged as the UAV is in the airborne phase of the flight.

Clause 49. The computer-readable storage medium of any of clauses 45 to 48, wherein the guidance modes are determined from built-in guidance modes including airborne flight modes for an airborne phase of the flight, and the airborne flight modes the include the lateral flight modes and the vertical flight modes.

Clause 50. The computer-readable storage medium of clause 49, wherein the airborne flight modes further include a lost-link mode and an approach mode, the lost-link mode engaged responsive to a lost-link event in which a datalink between the UAV and a control station is interrupted or lost.

Clause 51. The computer-readable storage medium of clause 49 or clause 50, wherein the built-in guidance modes further include ground modes for a ground phase of the flight, and air-ground transition modes for air-ground transition phases of the flight, and wherein the ground modes include a ground operations mode, a taxi mode, and a line-up mode, and the air-ground transition modes include a takeoff mode and a landing mode.

Clause 52. The computer-readable storage medium of any of clauses 45 to 51, wherein the guidance modes have defined transitions, and the defined transitions include a first type of transition from a first guidance mode to a second guidance mode in which the second guidance mode is engaged as the UAV is in the first guidance mode to effect the transition, responsive to a request when a specified condition is fulfilled.

Clause 53. The computer-readable storage medium of clause 52, wherein the defined transitions include a second type of transition in which the second guidance mode is engaged responsive to the request when the specified condition is fulfilled, and otherwise armed until the specified condition is fulfilled, at which time the second guidance mode is automatically engaged.

Clause 54. The computer-readable storage medium of clause 53, wherein the guidance modes further include a ground operations mode, a taxi mode, a line-up mode, and a takeoff mode, and wherein the defined transitions include transitions of the first type between the ground operations mode and the taxi mode, and from the line-up mode to the taxi mode, and the defined transitions include transitions of the second type from the taxi mode to the line-up mode, and from the line-up mode to the takeoff mode.

Clause 55. The computer-readable storage medium of clause 53 or clause 54, wherein the lateral flight modes include a lateral navigation mode, and further include track modes and heading modes, and wherein the defined transitions include transitions of the first type between the track modes, between the heading modes, between the track modes and the heading modes, and from the lateral navigation mode to the track modes and the heading modes, and the defined transitions include transitions of the second type from the track modes and the heading modes to the lateral navigation mode.

Clause 56. The computer-readable storage medium of any of clauses 53 to 55, wherein the guidance modes further include an approach mode, and the defined transitions include a transition of the second type from a combination of lateral flight mode and vertical flight mode to the approach mode, and a transition of the first type from the approach mode to the combination of lateral flight mode and vertical flight mode responsive to an aborted approach request.

Clause 57. The computer-readable storage medium of clause 56, wherein the guidance modes further include a landing mode, and the defined transitions include a transition of the second type from the approach mode to the landing mode.

Clause 58. The computer-readable storage medium of any of clauses 53 to 57, wherein the guidance modes further include a lost-link mode and an approach mode, the lost-link mode engaged responsive to a lost-link event in which a datalink between the UAV and a control station is interrupted or lost, and wherein the defined transitions include a transition of the first type from the lost-link mode to a combination of lateral flight mode and vertical flight mode when the datalink is recovered, and a transition of the second type from the lost-link mode to the approach mode when the UAV reaches an initial approach fix while still in the lost-link mode.

Clause 59. The computer-readable storage medium of any of clauses 52 to 58, wherein the defined transitions include a third type of transition from a first guidance mode to a second guidance mode in which the second guidance mode is automatically engaged to effect the transition when the specified condition is fulfilled.

Clause 60. The computer-readable storage medium of clause 59, wherein the guidance modes further include a takeoff mode, and the defined transitions include a transition of the third type from the takeoff mode to a combination of lateral flight mode and vertical flight mode.

Clause 61. The computer-readable storage medium of clause 60, wherein the guidance modes further include a taxi mode and an abort takeoff mode, and the defined transitions include transitions of the third type from the takeoff mode to the abort takeoff mode, and from the abort takeoff mode to the taxi mode.

Clause 63. The computer-readable storage medium of any of clauses 59 to 62, wherein the vertical flight modes include an altitude hold mode, a flight-level change mode, and a vertical speed mode, and wherein the defined transitions include transitions of the first type between the vertical flight modes, and transitions of the third type from the flight-level change mode and the vertical speed mode to the altitude hold mode.

Clause 64. The computer-readable storage medium of any of clauses 59 to 63, wherein the guidance modes further include a lost-link mode that is engaged responsive to a lost-link event in which a datalink between the UAV and a control station is interrupted or lost, and wherein the defined transitions include a transition of the third type from a combination of lateral flight mode and vertical flight mode to the lost-link mode, and a transition of the first type from the lost-link mode to the combination of lateral flight mode and vertical flight mode when the datalink is recovered.

Clause 65. The computer-readable storage medium of any of clauses 59 to 64, wherein the guidance modes further include a lost-link mode, an approach mode and a landing mode, the lost-link mode engaged responsive to a lost-link event in which a datalink between the UAV and a control station is interrupted or lost, and wherein the defined transitions include transitions of the third type from the approach mode and the landing mode to a combination of lateral flight mode and vertical flight mode responsive to a missed approach, and from the approach mode and the landing mode to the lost-link mode responsive to the missed approach during the lost-link event.

Clause 66. The computer-readable storage medium of any of clauses 59 to 65, wherein the guidance modes further include a landing mode, a taxi mode and a ground operations mode, and wherein the defined transitions include transitions of the third type from the landing mode to the taxi mode, and from the taxi mode to the ground operations mode, and the defined transitions include a transition of the first type from the ground operations mode to the taxi mode.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for supporting operations of an unmanned air vehicle (UAV) on a flight in an airspace system, the apparatus comprising:
a memory configured to store computer-readable program code; and
processing circuitry configured to access the memory, and execute the computer-readable program code to cause the apparatus to at least:
receive instructions that describe a cleared path the UAV is authorized by an air navigation service provider (ANSP) to travel through the airspace system;
determine guidance modes of the UAV based on the instructions, the guidance modes indicating procedures of the UAV, the guidance modes including lateral flight modes and vertical flight modes, that are subject to rules defined by the ANSP for travel through the airspace system under instrument flight rules (IFR), and the lateral flight modes and the vertical flight modes being separate and independent from one another; and
engage the guidance modes in which the UAV is caused to perform the procedures to carry out the flight.

2. The apparatus of claim 1, wherein the lateral flight modes include a lateral navigation mode, and further include track modes and heading modes, the track modes including track select and track hold modes, and the heading modes including heading select and heading hold modes, and
wherein the vertical flight modes include an altitude hold mode, a flight-level change mode, and a vertical speed mode.

3. The apparatus of claim 1, wherein the flight of the UAV is divided into phases including ground phases, air-ground transition phases, and an airborne phase, and one or more combinations of the lateral flight modes and the vertical flight modes are engaged as the UAV is in the airborne phase of the flight.

4. The apparatus of claim 1, wherein the guidance modes are determined from built-in guidance modes including airborne flight modes for an airborne phase of the flight, and the airborne flight modes the include the lateral flight modes and the vertical flight modes.

5. The apparatus of claim 4, wherein the airborne flight modes further include a lost-link mode and an approach mode, the lost-link mode engaged responsive to a lost-link event in which a datalink between the UAV and a control station is interrupted or lost.

6. The apparatus of claim 4, wherein the built-in guidance modes further include ground modes for a ground phase of the flight, and air-ground transition modes for air-ground transition phases of the flight, and
wherein the ground modes include a ground operations mode, a taxi mode, and a line-up mode, and the air-ground transition modes include a takeoff mode and a landing mode.

7. The apparatus of claim 1, wherein the guidance modes have defined transitions, and the defined transitions include a first type of transition from a first guidance mode to a second guidance mode in which the second guidance mode is engaged as the UAV is in the first guidance mode to effect the transition, responsive to a request when a specified condition is fulfilled.

8. The apparatus of claim 7, wherein the defined transitions include a second type of transition in which the second guidance mode is engaged responsive to the request when the specified condition is fulfilled, and otherwise armed until the specified condition is fulfilled, at which time the second guidance mode is automatically engaged.

9. The apparatus of claim 8, wherein the lateral flight modes include a lateral navigation mode, and further include track modes and heading modes, and
wherein the defined transitions include transitions of the first type between the track modes, between the heading modes, between the track modes and the heading modes, and from the lateral navigation mode to the track modes and the heading modes, and the defined transitions include transitions of the second type from the track modes and the heading modes to the lateral navigation mode.

10. The apparatus of claim 8, wherein the guidance modes further include a lost-link mode and an approach mode, the lost-link mode engaged responsive to a lost-link event in which a datalink between the UAV and a control station is interrupted or lost, and
wherein the defined transitions include a transition of the first type from the lost-link mode to a combination of lateral flight mode and vertical flight mode when the datalink is recovered, and a transition of the second type from the lost-link mode to the approach mode when the UAV reaches an initial approach fix while still in the lost-link mode.

11. The apparatus of claim 7, wherein the defined transitions include a third type of transition from a first guidance mode to a second guidance mode in which the second guidance mode is automatically engaged to effect the transition when the specified condition is fulfilled.

12. The apparatus of claim 11, wherein the guidance modes further include a takeoff mode, and the defined transitions include a transition of the third type from the takeoff mode to a combination of lateral flight mode and vertical flight mode.

13. The apparatus of claim 11, wherein the vertical flight modes include an altitude hold mode, a flight-level change mode, and a vertical speed mode, and
wherein the defined transitions include transitions of the first type between the vertical flight modes, and transitions of the third type from the flight-level change mode and the vertical speed mode to the altitude hold mode.

14. The apparatus of claim 11, wherein the guidance modes further include a lost-link mode that is engaged responsive to a lost-link event in which a datalink between the UAV and a control station is interrupted or lost, and
wherein the defined transitions include a transition of the third type from a combination of lateral flight mode and vertical flight mode to the lost-link mode, and a transition of the first type from the lost-link mode to the combination of lateral flight mode and vertical flight mode when the datalink is recovered.

15. The apparatus of claim 11, wherein the guidance modes further include a lost-link mode, an approach mode and a landing mode, the lost-link mode engaged responsive to a lost-link event in which a datalink between the UAV and a control station is interrupted or lost, and
wherein the defined transitions include transitions of the third type from the approach mode and the landing mode to a combination of lateral flight mode and vertical flight mode responsive to a missed approach, and from the approach mode and the landing mode to the lost-link mode responsive to the missed approach during the lost-link event.

16. A method of supporting operations of an unmanned air vehicle (UAV) on a flight in an airspace system, the method comprising:
receiving instructions that describe a cleared path the UAV is authorized by an air navigation service provider (ANSP) to travel through the airspace system;
determining guidance modes of the UAV based on the instructions, the guidance modes indicating procedures of the UAV, the guidance modes including lateral flight modes and vertical flight modes, that are subject to rules defined by the ANSP for travel through the airspace system under instrument flight rules (IFR), and the lateral flight modes and the vertical flight modes being separate and independent from one another; and
engaging the guidance modes in which the UAV is caused to perform the procedures to carry out the flight.

17. The method of claim 16, wherein the lateral flight modes include a lateral navigation mode, and further include track modes and heading modes, the track modes including track select and track hold modes, and the heading modes including heading select and heading hold modes, and
wherein the vertical flight modes include an altitude hold mode, a flight-level change mode, and a vertical speed mode.

18. The method of claim 16, wherein the flight of the UAV is divided into phases including ground phases, air-ground transition phases, and an airborne phase, and one or more combinations of the lateral flight modes and the vertical flight modes are engaged as the UAV is in the airborne phase of the flight.

19. The method of claim 16, wherein the guidance modes are determined from built-in guidance modes including airborne flight modes for an airborne phase of the flight, and the airborne flight modes the include the lateral flight modes and the vertical flight modes.

20. The method of claim 19, wherein the airborne flight modes further include a lost-link mode and an approach mode, the lost-link mode engaged responsive to a lost-link event in which a datalink between the UAV and a control station is interrupted or lost.

21. The method of claim 19, wherein the built-in guidance modes further include ground modes for a ground phase of the flight, and air-ground transition modes for air-ground transition phases of the flight, and
wherein the ground modes include a ground operations mode, a taxi mode, and a line-up mode, and the air-ground transition modes include a takeoff mode and a landing mode.

22. The method of claim 16, wherein the guidance modes have defined transitions, and the defined transitions include a first type of transition from a first guidance mode to a second guidance mode in which the second guidance mode is engaged as the UAV is in the first guidance mode to effect the transition, responsive to a request when a specified condition is fulfilled.

23. The method of claim 22, wherein the defined transitions include a second type of transition in which the second guidance mode is engaged responsive to the request when the specified condition is fulfilled, and otherwise armed until the specified condition is fulfilled, at which time the second guidance mode is automatically engaged.

24. The method of claim 23, wherein the lateral flight modes include a lateral navigation mode, and further include track modes and heading modes, and
wherein the defined transitions include transitions of the first type between the track modes, between the heading modes, between the track modes and the heading modes, and from the lateral navigation mode to the track modes and the heading modes, and the defined transitions include transitions of the second type from the track modes and the heading modes to the lateral navigation mode.

25. The method of claim 23, wherein the guidance modes further include a lost-link mode and an approach mode, the lost-link mode engaged responsive to a lost-link event in which a datalink between the UAV and a control station is interrupted or lost, and
wherein the defined transitions include a transition of the first type from the lost-link mode to a combination of lateral flight mode and vertical flight mode when the datalink is recovered, and a transition of the second type from the lost-link mode to the approach mode when the UAV reaches an initial approach fix while still in the lost-link mode.

26. The method of claim 22, wherein the defined transitions include a third type of transition from a first guidance mode to a second guidance mode in which the second guidance mode is automatically engaged to effect the transition when the specified condition is fulfilled.

27. The method of claim 26, wherein the guidance modes further include a takeoff mode, and the defined transitions include a transition of the third type from the takeoff mode to a combination of lateral flight mode and vertical flight mode.

28. The method of claim 26, wherein the vertical flight modes include an altitude hold mode, a flight-level change mode, and a vertical speed mode, and
wherein the defined transitions include transitions of the first type between the vertical flight modes, and transitions of the third type from the flight-level change mode and the vertical speed mode to the altitude hold mode.

29. The method of claim 26, wherein the guidance modes further include a lost-link mode that is engaged responsive to a lost-link event in which a datalink between the UAV and a control station is interrupted or lost, and
wherein the defined transitions include a transition of the third type from a combination of lateral flight mode and vertical flight mode to the lost-link mode, and a transition of the first type from the lost-link mode to the combination of lateral flight mode and vertical flight mode when the datalink is recovered.

30. The method of claim 26, wherein the guidance modes further include a lost-link mode, an approach mode and a landing mode, the lost-link mode engaged responsive to a lost-link event in which a datalink between the UAV and a control station is interrupted or lost, and
wherein the defined transitions include transitions of the third type from the approach mode and the landing mode to a combination of lateral flight mode and vertical flight mode responsive to a missed approach, and from the approach mode and the landing mode to the lost-link mode responsive to the missed approach during the lost-link event.
